SEQUENCE LISTING (6 sequences)

SEQ ID NO: 1 - protein, 9 aa, Artificial Sequence
  synthesised peptide sequence
VMAPRTLVL

SEQ ID NO: 2 - protein, 9 aa, Artificial Sequence
  synthesised peptide sequence
ALAKVRMAI

SEQ ID NO: 3 - protein, 9 aa, Artificial Sequence
  synthesised peptide sequence
GILGFVFTL

SEQ ID NO: 4 - protein, 9 aa, Artificial Sequence
  synthesised peptide sequence
YIVGANIET

SEQ ID NO: 5 - protein, 1960 aa, Homo sapiens
MAQQAADKYLYVDKNFINNPLAQADWAAKKLVWVPSDKSGFEPASLKEEVGEEAIVELVENGKKVKVNKDDIQKMNPPKFSKVEDMAELTCLNEASVLHNLKERYYSGLIYTYSGLFCVVINPYKNLPIYSEEIVEMYKGKKRHEMPPHIYAITDTAYRSMMQDREDQSILCTGESGAGKTENTKKVIQYLAYVASSHKSKKDQGELERQLLQANPILEAFGNAKTVKNDNSSRFGKFIRINFDVNGYIVGANIETYLLEKSRAIRQAKEERTFHIFYYLLSGAGEHLKTDLLLEPYNKYRFLSNGHVTIPGQQDKDMFQETMEAMRIMGIPEEEQMGLLRVISGVLQLGNIVFKKERNTDQASMPDNTAAQKVSHLLGINVTDFTRGILTPRIKVGRDYVQKAQTKEQADFAIEALAKATYERMFRWLVLRINKALDKTKRQGASFIGILDIAGFEIFDLNSFEQLCINYTNEKLQQLFNHTMFILEQEEYQREGIEWNFIDFGLDLQPCIDLIEKPAGPPGILALLDEECWFPKATDKSFVEKVMQEQGTHPKFQKPKQLKDKADFCIIHYAGKVDYKADEWLMKNMDPLNDNIATLLHQSSDKFVSELWKDVDRIIGLDQVAGMSETALPGAFKTRKGMFRTVGQLYKEQLAKLMATLRNTNPNFVRCIIPNHEKKAGKLDPHLVLDQLRCNGVLEGIRICRQGFPNRVVFQEFRQRYEILTPNSIPKGFMDGKQACVLMIKALELDSNLYRIGQSKVFFRAGVLAHLEEERDLKITDVIIGFQACCRGYLARKAFAKRQQQLTAMKVLQRNCAAYLKLRNWQWWRLFTKVKPLLQVSRQEEEMMAKEEELVKVREKQLAAENRLTEMETLQSQLMAEKLQLQEQLQAETELCAEAEELRARLTAKKQELEEICHDLEARVEEEEERCQHLQAEKKKMQQNIQELEEQLEEEESARQKLQLEKVTTEAKLKKLEEEQIILEDQNCKLAKEKKLLEDRIAEFTTNLTEEEEKSKSLAKLKNKHEAMITDLEERLRREEKQRQELEKTRRKLEGDSTDLSDQIAELQAQIAELKMQLAKKEEELQAALARVEEEAAQKNMALKKIRELESQISELQEDLESERASRNKAEKQKRDLGEELEALKTELEDTLDSTAAQQELRSKREQEVNILKKTLEEEAKTHEAQIQEMRQKHSQAVEELAEQLEQTKRVKANLEKAKQTLENERGELANEVKVLLQGKGDSEHKRKKVEAQLQELQVKFNEGERVRTELADKVTKLQVELDNVTGLLSQSDSKSSKLTKDFSALESQLQDTQELLQEENRQKLSLSTKLKQVEDEKNSFREQLEEEEEAKHNLEKQIATLHAQVADMKKKMEDSVGCLETAEEVKRKLQKDLEGLSQRHEEKVAAYDKLEKTKTRLQQELDDLLVDLDHQRQSACNLEKKQKKFDQLLAEEKTISAKYAEERDRAEAEAREKETKALSLARALEEAMEQKAELERLNKQFRTEMEDLMSSKDDVGKSVHELEKSKRALEQQVEEMKTQLEELEDELQATEDAKLRLEVNLQAMKAQFERDLQGRDEQSEEKKKQLVRQVREMEAELEDERKQRSMAVAARKKLEMDLKDLEAHIDSANKNRDEAIKQLRKLQAQMKDCMRELDDTRASREEILAQAKENEKKLKSMEAEMIQLQEELAAAERAKRQAQQERDELADEIANSSGKGALALEEKRRLEARIAQLEEELEEEQGNTELINDRLKKANLQIDQINTDLNLERSHAQKNENARQQLERQNKELKVKLQEMEGTVKSKYKASITALEAKIAQLEEQLDNETKERQAACKQVRRTEKKLKDVLLQVDDERRNAEQYKDQADKASTRLKQLKRQLEEAEEEAQRANASRRKLQRELEDATETADAMNREVSSLKNKLRRGDLPFVVPRRMARKGAGDGSDEEVDGKADGAEAKPAE

SEQ ID NO: 6 - protein, 9 aa, Artificial Sequence
  synthesised peptide sequence
RVMAPRALL

(19) United States
(12) Patent Application Publication
(10) Pub. No.: US 2012/0239367 A1
(43) Pub. Date: Sep. 20, 2012

(54) METHOD AND SYSTEM FOR EVALUATING A POTENTIAL LIGAND-RECEPTOR INTERACTION

(76) Inventors: Joo Chuan Victor Tong, Singapore (SG); Ee Chee Ren, Singapore (SG)

(21) Appl. No.: 13/498,134

(22) PCT Filed: Sep. 20, 2010
(86) PCT No.: PCT/SG10/00352

§ 371 Date: Mar. 23, 2012

(30) Foreign Application Priority Data
Sep. 25, 2009 (SG) 20906589-7

(51) Int. Cl. G06G 7/60

(52) U.S. Cl. 703/11

(57) ABSTRACT

A method for evaluating a potential interaction between a ligand and a receptor is disclosed. The method comprises the step of: evaluating the potential interaction between the ligand and the receptor based on a predictive model trained using a database. The database describes the affinity with the receptor of a source ligand, and a plurality of additional ligands derived from the source ligand.

### FIELD OF THE INVENTION

The present invention relates to a method and system for evaluating a potential interaction between a ligand and a receptor. The method and system can be used to predict ligand-receptor interaction patterns or the activity of a test protein.

### BACKGROUND OF THE INVENTION

The association of two molecules is a fundamental biological event that is essential for the initiation and regulation of biological responses. In this document, the term “molecule” refers to (but is not limited to) nucleic acids, proteins, carbohydrates, lipids, chemicals or macromolecules.

When a ligand binds to a receptor to form a complex, the complex initiates a cascade of reactions that induces a change in the state of a targeted cell. The new state of the cell results in a biological response, such as enzyme activation or deactivation, protein synthesis, protein stabilization, release of hormones or transmitters, activation of immune cascades, among others. A ligand may be an atom, an ion or a molecule. Examples of ligands include hormones, pheromones, neurotransmitters, peptides, drugs, inhibitors, and small molecules.

Understanding the structural principles involved in ligand-receptor interaction is important for the analysis of biological responses, chemical responses, and related processes. A receptor may bind multiple types of ligands, or the same ligand may be recognized by multiple types of receptors. Furthermore, a cell may contain multiple copies of a particular type of receptor, or the same type of receptor may be present in different cells. In addition, some receptors belong to families with a large number of variants.

Typically, the binding sites on a protein (which may be a ligand or a receptor) are highly specific and a small difference in the amino acid residues of the protein is sufficient to alter the function of the protein. Thus, even if two proteins share similar structures, they may have different functions. Screening a family of receptors for their ligands or vice-versa through wet lab experimentation is impractical due to the large number of possible structural arrangements.

Major histocompatibility complex (MHC) molecules bind and present antigens as short peptide fragments to T cell receptors (TCR) on the surfaces of T cells. These same proteins process the antigens in vaccines, triggering resistance. Two classes of MHC molecules are responsible for antigen presentation: i) MHC class I molecules, which present endogenous peptides to CD8+ T cytotoxic (Tc) cells, and ii) MHC class II molecules, which present exogenous peptides to CD4+ T helper (Th) cells. Tc cells release cytotoxins which are responsible for cell lysis, and granzymes which induces apoptosis. Th1 cells produce interferon γ (IFN-γ) and tumor necrosis factor β (TNF-β) and are involved in delayed-type hypersensitivity (DTH) reactions. By contrast, Th2 cells produce interleukin IL-4, IL-5, IL-10 and IL-13, which are responsible for strong antibody responses, including the activation and recruitment of IgE antibody-producing B-cells, mast cells, eosinophils, and the inhibition of several macrophage functions.

In general, all MHC molecules share certain structural characteristics that are critical for their role in peptide display and recognition by T cells. T cell recognition of antigens is said to be MHC restricted, as the TCRs of a T cell will only bind to fragments of antigens that are associated with products of a particular type of MHC molecule. Each MHC molecule contains an extracellular peptide-binding cleft which is composed of paired α-helices resting on a floor consisting of an eight-stranded anti-parallel β-sheet. This portion of the MHC molecule binds antigenic peptides for display to T cells, and the TCRs of the T cells interact with the displayed peptides and the helices of the MHC molecules. The amino acid residues located in and around the peptide-binding cleft of the MHC molecule are highly polymorphic and are responsible for the peptide binding specificities among different MHC alleles. A non-polymorphic determinant on the MHC molecule acts as the binding site for the T cell co-receptor molecules CD4 and CD8. CD4 and CD8 are expressed on distinct subpopulations of mature T cells and together with the antigen receptors, participate in the recognition of antigens. CD8 binds selectively to class I MHC molecules, and CD4 binds to class II MHC molecules. In other words, CD8⁺ T cells recognize only peptides displayed by class I MHC molecules whereas CD4⁺ T cells recognize only peptides presented by class II MHC molecules. Most CD8⁺ T cells function as cytotoxic T cells and CD4⁺ T cells function as T helper cells.

T cell epitopes are short peptides displayed on the surface of cells, in conjunction with MHC molecules that are recognized by T-cells. T cell epitope mapping, including MHC-peptide binding, is currently one of the most intensively researched areas of molecular and cellular immunology. Two main categories of specialized bioinformatics tools are available for prediction of MHC-binding peptides—(i) methods based on identifying patterns in sequences of binding peptides, and (ii) methods that employ three-dimensional (3-D) structures to model peptide/MHC interactions (Tong et al., 2007). The first category (category (i)) employs procedures based on binding motifs (Falk et al., 1991), binding matrices (Schafer et al., 1998), decision trees (Segal et al., 2001), hidden Markov models (HMM) (Mamitsuka, 1989), support vector machines (SVM) (Zhao et al., 2003) and artificial neural networks (ANN) (Nielsen et al., 2003). In contrast, the second category (category (ii)) employs techniques with distinct theoretical lineage and includes the use of homology modeling (Michielin et al., 2000), quantitative structure-activity relationship (QSAR) analysis (Doytchinova and Flower, 2001), protein threading (Altuvia et al., 1995) and docking techniques (Bordner and Abagyan, 2006).

### SUMMARY OF THE INVENTION

The present invention aims to provide new and useful computerized systems for evaluating a potential interaction between a ligand and a receptor, for example, between a T cell epitope and a TCR.

In general terms, the present invention proposes evaluating potential interactions between ligands and receptors by using not only ligand-receptor interactions with known or estimated affinities but also ligand-receptor interactions derived from these ligand-receptor interactions with known or estimated affinities.

Specifically, a first aspect of the present invention is a method for generating a predictive model for evaluating ligand interactions with a receptor. The predictive model is generated based on a database indicating the affinity between the receptor and a plurality of ligands generated from at least one source ligand which is known to interact with the receptor. The plurality of ligands may be generated by modifying the source ligand(s) at locations on the source ligand(s) where interaction with the receptor occurs.

The model may then be used in a method of evaluating a potential interaction between a specified ligand and the receptor, by inputting to the predictive model data describing the specified ligand and receptor.

The invention may alternatively be expressed as a computer system for performing such a method. This computer system may be integrated with a device for extracting properties of test ligands and test receptors from, for example, online databanks. The invention may also be expressed as a computer program product, such as one recorded on a tangible computer medium, containing program instructions operable by a computer system to perform the steps of the method.

### BRIEF DESCRIPTION OF THE FIGURES

An embodiment of the invention will now be illustrated for the sake of example only with reference to the following drawings, in which:

FIG. 1(a) illustrates a method for training a predictive model according to an embodiment of the present invention and FIG. 1(b) illustrates a method for evaluating a potential interaction between a ligand and a receptor using the trained predictive model of FIG. 1(a);

FIG. 2 illustrates an example rotamer library constructed in the method of FIG. 1(a);

FIG. 3 illustrates an example process for obtaining a part of a representation for a ligand-receptor interaction in the method of FIG. 1(a);

FIGS. 4(a)-(b) respectively illustrate example representations for a peptide interaction site of a receptor and a ligand-receptor interaction, and FIG. 4(c) illustrates a format suitable for training the predictive model in the method of FIG. 1(a).

### DETAILED DESCRIPTION OF THE EMBODIMENTS

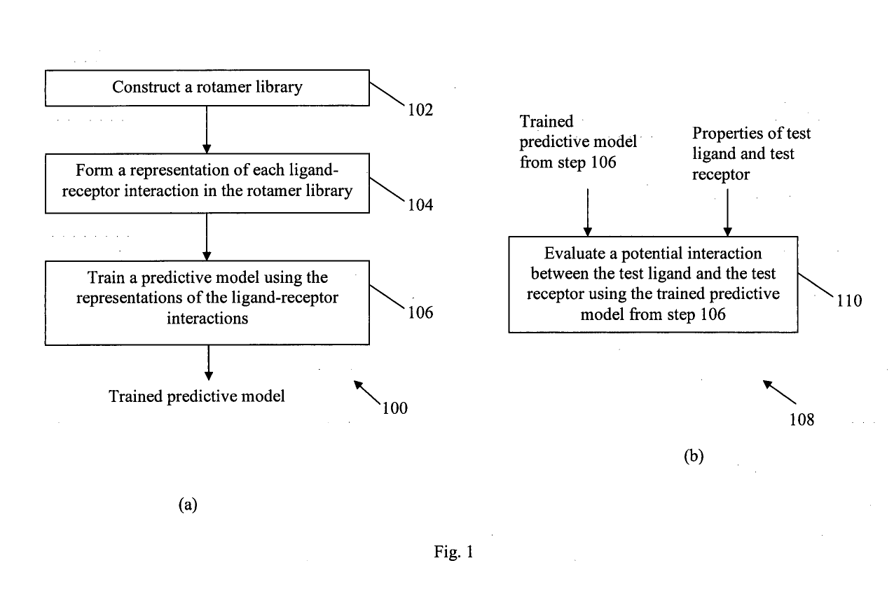

Referring to FIG. 1(a), the steps are illustrated of a method 100 which is an embodiment of the present invention, and which trains a predictive model.

In step 102, at least one training ligand and a training receptor are identified and using these training ligands and receptor, a database management system (or in short, a database) in the form of a rotamer library is constructed. In step 104, a representation of each ligand-receptor interaction in the rotamer library is formed. In step 106, a predictive model is trained using the representations of the ligand-receptor interactions.

Referring to FIG. 1(b), the steps are illustrated of a method 108 which evaluates a potential interaction between a ligand and a receptor using the trained predictive model from step 106 of method 100.

The input to step 110 of method 108 comprises properties of a test ligand and a test receptor, and the trained predictive model from step 106. In step 110, the potential interaction between the test ligand and the test receptor is evaluated using the trained predictive model. This evaluation may provide information on whether the test ligand binds with the test receptor and if so, how strong the binding is and what chemical bonds are involved in the binding etc.

These steps will now be described in more detail.

### Rotamer Library Design

In step 102, a rotamer library is constructed. The rotamer library comprises at least one base ligand-receptor interaction of known or estimated affinity and at least one ligand-receptor interaction derived from the base ligand-receptor interaction(s). In one example, the rotamer library may comprise all possible ligand-receptor interactions for a receptor of interest.

In one example, step 102 comprises the following sub-steps for a receptor of interest:
(a) A source ligand (or a scaffold) known to bind to the receptor of interest is first identified. The interaction between this source ligand and the receptor of interest is referred to as a base ligand-receptor interaction of known affinity.
(b) Next, a 3-D structure of the ligand-receptor complex resulting from the base ligand-receptor interaction is obtained. The 3-D structure may either be an experimentally solved 3-D protein structure, a computational model or a theoretical model. The computational model or theoretical model may be derived with homology modelling, molecular docking and/or protein threading techniques.
(c) Next, a portion of the source ligand is modified to produce at least one modified ligand with characteristics substantially similar to that of the source ligand. The portion to be modified may be a portion known to bind with the receptor of interest.

In one example, the portion to be modified comprises the side chain coordinates (P₁, P₂ . . . P_{N}) of an amino acid residue in the source ligand whereby these side chain coordinates are known to bind with the receptor of interest. This modification is performed by substituting the side chain coordinates (P₁, P₂ . . . P_{N}) with the side chain coordinates of every other possible amino acid residue. In other words, if a possible amino acid residue has side chain coordinates (S₁, S₂ . . . S_{N}), Pᵢ is substituted with Sᵢ. An amino acid residue refers to an organic compound containing an amino group (NH₂), a carboxylic acid group (COON), and any of various side groups, especially any of the 20 compounds that have the basic formula NH₂CHRCOOH, and two or more amino acid residues can be linked together by peptide bonds to form proteins. Amino acid residues can function as chemical messengers or as intermediates in metabolism pathways.
(d) Next, receptor residues that interact with the position-specific residue of the source ligand and receptor residues that interact with the position-specific residue of each modified ligand are identified. A “position-specific” residue of a peptide refers to a residue at a specific location within the peptide sequence (using peptide sequences VMAPRTLVL (SEQ ID NO: 1) and ALAKVRMAI (SEQ ID NO: 2) as examples, the amino acid residues M and L occur at position 2 of the peptide sequences VMAPRTLVL (SEQ ID NO: 1) and ALAKVRMAI (SEQ ID NO: 2) respectively). In this step, the position-specific residue of the source ligand refers to the amino acid residue whose side chain coordinates are to be substituted whereas the position-specific residue of the modified ligand refers to the amino acid residue whose side chain coordinates have been substituted. The information obtained from this step is used for training the predictive model in a later step.
(e) The base ligand-receptor interaction and the interactions between each of the modified ligands from (c) and the receptor (i.e. the ligand-receptor interactions derived from the base ligand-receptor interaction) are then stored in the rotamer library.
   In one example, each stored ligand-receptor interaction in the rotamer library is defined by the ligand contact elements and the receptor contact elements of the interaction. These contact elements are amino acid residues which affect the ligand-receptor interaction (either directly or indirectly).
   The ligand-receptor contact elements for the base ligand-receptor interaction may be derived from the ligand and receptor residues found in step (d) and from the 3-D structure obtained in step (b), in other words, they may be 3-D structure-derived. In one example, these contact elements are derived using a cut-off distance between the ligand and the receptor. The contact elements for the interactions between the modified ligands and the receptor may be derived in the same manner.
   Where necessary, each ligand-receptor interaction in the rotamer library may be provided with a variance in order to provide a degree of relaxation. For example, the distance between the contact elements of the ligand and the receptor in each ligand-receptor interaction may be stored in the rotamer library as a range of values instead of as a single value.

The rotamer library may be further expanded using different crystal structures of the receptor or by listing different sets of contact elements found using different criteria or thresholds.

### Example 1

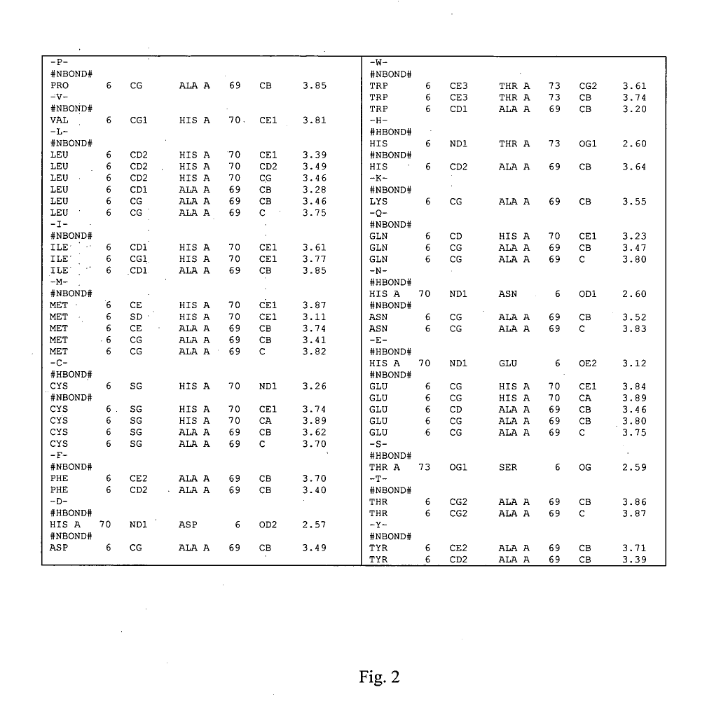

FIG. 2 illustrates an example rotamer library constructed in step 102. More specifically, FIG. 2 shows the rotamer library of the P6 interaction site of peptide GILGFVFTL (SEQ ID NO: 3) in complex with the HLA-A*0201 molecule.

The positional binding environments of nonameric peptide GILGFVFTL (SEQ ID NO: 3) of influenza A virus matrix protein 1 antigen binding to HLA-A*0201 molecule have been resolved by X-ray crystallography (PDB ID: 1OGA; Steward-Jones G B, McMichael A J, Bell J I, Stuart D I, Jones E Y. A structural basis for immunodominant human T cell receptor recognition. Nat Immunol 2003; 4:657-663). Substituting the side chain coordinates at position (P) 6 of the peptide GILGFVFTL (SEQ ID NO: 3) by homology modeling (Bino J, Sali A. Comparative protein structure modeling by iterative alignment, model building and model assessment. Nucleic Acids Res 2003; 31:3982-3992), and putting together the side chain coordinates of every other possible amino acid and its relevant atoms in contact with the HLA-A*0201 molecule (as described in sub-step (b) of step 102 above), results in the rotamer library as shown in FIG. 2.

In FIG. 2, NBOND and HBOND represent hydrophobic and hydrogen bonding contacts respectively. P, V, L, I, M, C, F, D, W, H, K, Q, N, E, S, T and Y are respectively representations of amino acid residues: proline, valine, leucine, isoleucine, methionine, cysteine, phenylalanine, aspartic acid, tryptophan, histidine, lysine, glutamine, asparagine, glutamic acid, serine, threonine and tyrosine. If a given amino acid residue is shown as only having an “NBOND” element in the library, it means that no hydrogen bonding (HBOND) is observed for the atoms in that amino acid residue. The same applies for a given amino acid residue shown as only having an “HBOND” element.

FIG. 2 shows the rotamer library in the form of a table split into two sides, each side having a total of 8 columns. Column 1 shows the amino acid residue whose side chain coordinates are used for the substitution in step (c) above. Column 2 shows the position of the amino acid residue whose side chain coordinates have been substituted in the ligand. Column 3 shows the atom name of an atom in the amino acid residue in column 1. This atom is part of the substituted side chain coordinates in the modified ligand and is listed in the form of CE1, CD2, CG etc.

Column 4 shows the amino acid residue in the receptor in contact with the atom in column 3. Column 5 shows the chain of the amino acid residue in column 4. Column 6 shows the position of the amino acid residue in column 4 in the receptor. Column 7 shows the atom name of an atom in the amino acid residue in column 4. This receptor atom contacts the ligand atom listed in column 3. For example, “Leu 6 CD2 HIS A 70 CE1 3.39” indicates that the atom CD2 which is part of the side chain coordinates of the amino acid residue Leu and which is now part of the substituted side chain coordinates of the amino acid residue at position 6 of the modified ligand is interacting with the atom CE1 from the receptor amino acid residue Histidine (His) at position 70 of the receptor. Column 8 shows the distance between the ligand atom in column 3 and the receptor atom in column 7.

The number of entries for each amino acid residue in column 1 represents the number of atoms in the side chain coordinates of the amino acid residue which contact the receptor. For example, only one atom of Valine (Val) is in contact with the receptor whereas a total of six atoms of Leucine (Leu) are in contact with the receptor. These atomic contacts may be derived from crystal structures or computational modeling. The atoms in the side chain coordinates of each amino acid residue in column 1 can interact with more than one receptor amino acid residue. For example, the atoms in the side chain coordinates of Leu can interact with either the amino acid residue HIS at position 70 in the receptor or the amino acid residue ALA at position 69 in the receptor.

Note that FIG. 2 does not show the amino acid residue in the source ligand whose side chain coordinates are to be substituted. However, this amino acid residue may be included in the rotamer library.

### Coding Procedure

In step 104, a representation is formed for each ligand-receptor interaction in the rotamer library using a coding procedure and the representation is converted to a format suitable for training a predictive model.

The representation formed in step 104 describes the characteristics of the ligand-receptor interaction. These characteristics may comprise ligand contact elements and receptor contact elements of the interaction. They may also comprise the chemical bonds involved in the interaction and/or a strength of the interaction.

In one example, the coding procedure of step 104 comprises the following sub-steps:
(a) First, the ligand-receptor interactions (defined by the ligand contact elements and the receptor contact elements of the interactions) are extracted from the rotamer library.
(b) For each extracted ligand-receptor interaction, the types of chemical bonds contributing to the interaction are then identified.
(c) Next, for each extracted ligand-receptor interaction, a representation for the ligand contact elements, a representation for the receptor contact elements and a representation for the chemical bonds are constructed. These representations are then combined to form the representation for the ligand-receptor interaction. In one example, these representations are concatenated to form a linear representation for the ligand-receptor interaction.
   Note that the contact elements included in the representation may exclude the conserved residues. Furthermore, the representation of the chemical bonds may be omitted when forming the representation of the ligand-receptor interaction.
(d) A format suitable for use with (in particular, for training) a predictive model is then selected. The representation of each ligand-receptor interaction is then converted into this format for training the predictive model.

### Example 2

Peptide YIVGANIET (SEQ ID NO: 4) of the myosin-9 (248-256) antigen (UniProt accession: P35579, SEQ ID NO: 5) binds HLA-A*0201 molecule (Sidney J, Rawson P, Barnaba V, Sette A (2006) Immune Epitope Database and Analysis Resource Online Submission; http://www.immuneepitope.org/refld/1000396). The interaction site of the peptide with the cleft of the HLA-A*0201 molecule is the whole length of the peptide. The positional binding environments of the peptide have been resolved by X-ray crystallography (PDB ID 1OGA; Stewart-Jones G B, McMichael A J, Bell J I, Stuart D I, Jones E Y. 2003, A structural basis for immunodominant human T cell receptor recognition. Nat Immunol 4, 657-663).

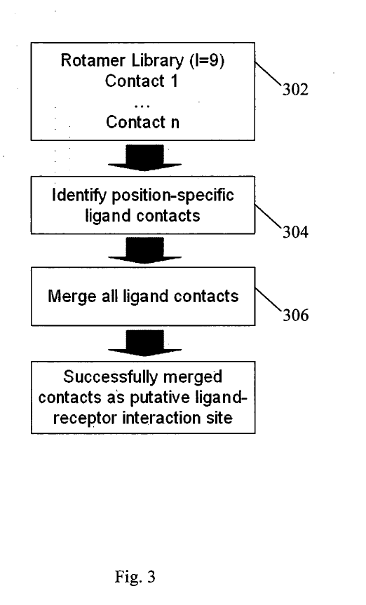

FIG. 3 shows an example process of obtaining a part of the representation for the interaction between the YIVGANIET (SEQ ID NO: 4) peptide (ligand) and the HLA-A*0201 molecule (receptor).

As shown in FIG. 3, the example process comprises sub-steps 302-306. In sub-step 302, the ligand contact elements (Contact 1 . . . Contact n) for the interaction between the YIVGANIET peptide (SEQ ID NO: 4) and the HLA-A*0201 molecule are extracted from the rotamer library. Next in sub-step 304, position-specific ligand contact elements are identified. In sub-step 306, all the position-specific ligand contact elements are then merged. These successfully merged ligand contact elements are part of the representation of the putative ligand-receptor interaction site.

HLA-A*0201 has 18 amino acids on the surface of the binding groove (Y171 R170 Y159 W167 Y59 K66 E63 V67 Y7 Y99 H70 A69 T73 W147 V76 K146 T143 Y84) that are in contact with the said peptide. These amino acids form the receptor interaction site. Putting together the interactions mediated by hydrogen bonds and by hydrophobic contacts (in this example, the whole 9-mer peptide (i.e. the ligand contact elements) and the receptor interaction site) results in the full representation of the interaction between the YIVGANIET peptide (SEQ ID NO: 4) and the HLA-A*0201 molecule.

### Data Preparation for SVM Training

The representation of a ligand-receptor interaction formed in step 104 may be expressed as LIS:TP-RIS-BA, where LIS represents ligand contact elements (amino acid residue or atom) of the interaction, TP represents chemical bonds involved in the interaction, RIS represents receptor contact elements (amino acid residue or atom) of the interaction, and BA represents a measured strength of the interaction (i.e. the binding affinity). Note that BA is optional in the representation and that the binding affinity may be zero i.e. the ligand does not bind to the receptor. Furthermore, the amino acid residues may be represented in the format as shown in Table 1.

TABLE 1

| Amino Acid | Representation |
|---|---|
| Alanine (A) | 10000000000000000000 |
| Cysteine (C) | 01000000000000000000 |
| Aspartate (D) | 00100000000000000000 |
| Glutamate (E) | 00010000000000000000 |
| Phenylalanine (F) | 00001000000000000000 |
| Glycine(G) | 00000100000000000000 |
| Histidine (H) | 00000010000000000000 |
| Isoleucine (I) | 00000001000000000000 |
| Lysine (K) | 00000000100000000000 |
| Leucine (L) | 00000000010000000000 |
| Methionine (M) | 00000000001000000000 |
| Asparagine (N) | 00000000000100000000 |
| Proline (P) | 00000000000010000000 |
| Glutamine (Q) | 00000000000001000000 |
| Arginine (R) | 00000000000000100000 |
| Serine (S) | 00000000000000010000 |
| Threonine (T) | 00000000000000001000 |
| Valine (V) | 00000000000000000100 |
| Tryptophan (W) | 00000000000000000010 |
| Tyrosine (Y) | 00000000000000000001 |

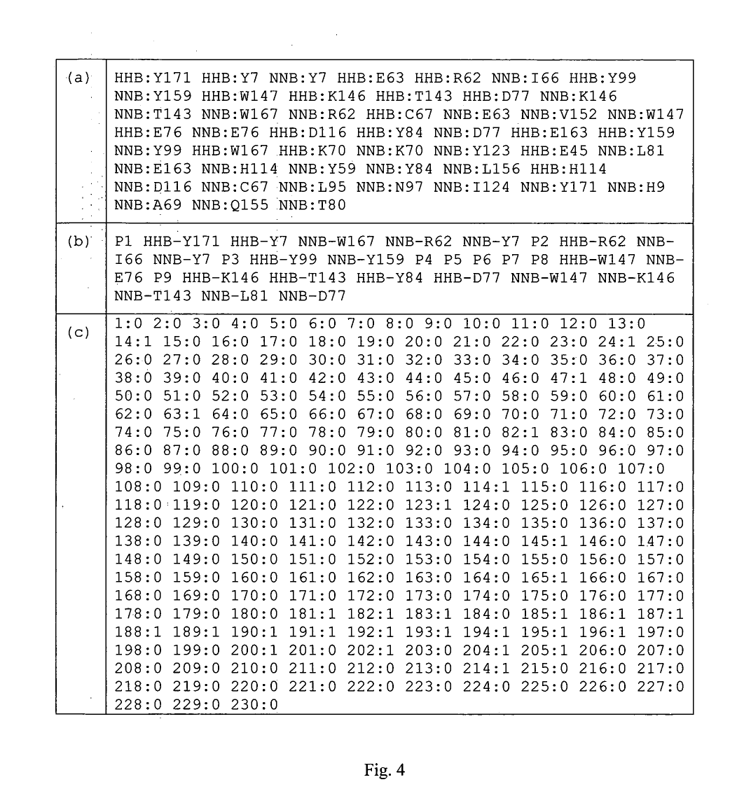

Alternatively, the representation of the ligand-receptor interaction may be in other forms. An alternative representation of the ligand-receptor interaction is illustrated in FIGS. 4(a) and 4(b) which will be elaborated below.

### Example 3

The binding affinities of a number of peptides (for example, the RVMAPRALL peptide, SEQ ID NO: 6) to the HLA class I molecule HLA-B*2705 have been measured. The 3-D structure of the B*2705 molecule has also been determined using X-ray crystallography. (Ruckert C, Fiorillo M T, Loll B, Moretti R, Biesiadka J, Saenger W, Ziegler A, Sorrentino R, Uchanska-Ziegler B. Conformational dimorphism of self-peptides and molecular mimicry in a disease-associated HLA-B27 subtype. J Biol Chem 2006; 281:2306-2316).

FIG. 4(a) shows the representations of the peptide contact residues at the peptide interaction site of the B*2705 molecule whereby NNB indicates that the contact residue is a hydrophobic bonding contact and HHB indicates that the contact residue is a hydrogen bonding contact. Note that not all the peptide contact residues at the peptide interaction site serve as contact elements in the interaction between the B*2705 molecule and the RVMAPRALL peptide (SEQ ID NO: 6).

FIG. 4(b) shows an example representation of the RVMAPRALL-B*2705 interaction. In FIG. 4(b), Pi (P1-P9) represents the peptide position in the RVMAPRALL peptide (SEQ ID NO: 6) and the residues following Pi represent the contact elements within B*2705 contacting the amino acid residue at the peptide position Pi. For example, the residue at P1 of RVMAPRALL(SEQ ID NO: 6) is a ligand contact element contacting residues Y171, Y7, W167, R62 and Y7 of B*2705. These residues Y171, Y7, W167, R62 and Y7 are the receptor contact elements. Similarly, HHB indicates that the bond between the contact elements is a hydrogen bond whereas NNB indicates that the bond between the contact elements is a hydrophobic bond.

FIG. 4(c) shows a format suitable for training a predictive model, for example, a machine learning model such as a SVM model. This format can be used to represent the RVMAPRALL-B*2705 interaction in FIGS. 4(a) and 4(b). However, note that the entries in FIG. 4(c) merely illustrate a suitable format for training the predictive model and do not reflect the RVMAPRALL-B*2705 interaction shown in FIG. 4(b).

To convert the information in FIG. 4(a) and FIG. 4(b) to the format shown in FIG. 4(c), each entry A:B in FIG. 4(a) is assigned a unique identifier and a binary value. The unique identifier is assigned based on the sequence of the entries A:B as listed in FIG. 4(a). For example, HHB:Y171 is assigned an identifier of 1 whereas HHB:Y7 is assigned an identifier of 2. The binary value is assigned based on whether the entry A:B represents a contact element involved in the ligand-receptor interaction shown in FIG. 4(b). For example, if an entry A:B does not represent a contact element in the ligand-receptor interaction, it is assigned a binary value of 0. On the other hand, if the entry A:B represents a contact element in the ligand-receptor interaction, it is assigned a binary value of 1. The overall representation of each entry A:B is in a format combining the unique identifier and the binary value. For example, an entry with a unique identifier of 1 is represented as 1:0 if it does not represent a contact element in the ligand-receptor interaction whereas an entry with a unique identifier of 2 is represented as 2:1 if it represents a contact element in the ligand-receptor interaction.

### Implementation

The representations formed in step 104 (i.e. the representations used to train the predictive model) characterize at least one ligand-receptor interaction of known binding affinity, for example, the base ligand-receptor interaction in Example 1. In step 106, the representations of the ligand-receptor interactions formed in step 104 are used to train a predictive model. The predictive model may be trained using probabilistic means (e.g. probability density function), fuzzy means, multiple regression means, matrices, Bayesian networks, or machine-learning algorithms such as Artificial Neural Network (ANN), Hidden Markov Model (HMM) or Support Vector Machine (SVM).

In Example 1, the base ligand-receptor interaction is of known affinity. However, if no ligand-receptor interaction of known binding affinity is available (for example, due to a lack of experimental data), a base ligand-receptor interaction of an estimated affinity may be used instead. For example, if the binding activity of a ligand-receptor interaction is unknown, but there is experimental evidence of biological activity resulting from the ligand-receptor interaction, a reasonable estimate of the binding affinity between the ligand and the receptor can be deduced and used for training the predictive model.

The trained predictive model is then used in step 110 of method 108. This trained predictive model may be used to evaluate a ligand-receptor interaction of unknown binding affinity.

In one example, properties of a test ligand and a test receptor whose interaction is of unknown binding affinity are input into step 110. Based on these properties (e.g. the peptide sequences), a 3-D structure of a complex formed by the potential interaction may be estimated and from this estimated 3-D structure, possible contact elements may be derived. The potential interaction between the test ligand and the test receptor is then represented in the same format as the representations formed in step 104 using these possible contact elements. Next, this representation is converted to a format suitable for use with the trained predictive model (for example, the format in FIG. 4(c)) and is then presented to the trained predictive model. Subsequently, the potential ligand-receptor interaction is evaluated using the representation and the trained predictive model so as to predict the interaction characteristics for example, whether the ligand binds to the receptor, and if so, the chemical bonds of the binding and how strong the binding is etc.

Method 108 may also be used to analyze a test protein (which may be a ligand or a receptor). In this example, the predictive model of method 100 is used to predict the binding activities of the test protein. This in turn, predicts the functionality and reactivity of the test protein. In one example, representations of a series of descriptors defining different characteristics of the test protein may be extracted from the rotamer library and may be combined. The combination of these representations may then be presented to the previously trained predictive model to evaluate the potential interactions between the test protein and one or more related ligands or related receptors.

### Example 4

The binding affinities of a number of peptides have been measured for seven HLA class I molecules A*0101, A*0202, A*0203, A*0301, A*1101, A*2301 and A*2601. As the 3-D structures of A*0101, A*0202, A*0203, A*0301, A*1101, A*2301 and A*2601 are not available, theoretical 3-D models of these receptors are generated using homology modeling (Bino J, Sali A. Comparative protein structure modeling by iterative alignment, model building and model assessment. Nucleic Acids Res 2003; 31:3982-3992).

In this example, the interaction sites for the seven HLA class I molecules are represented in the same format as in Example 3—FIG. 4(a). The interactions between these HLA class I molecules and peptides known to bind to these molecules are also represented in the same format as in Example 3—FIG. 4(b). The training data comprises binding and non-binding 9-mer peptides for each HLA class I molecule. This training data was obtained from Immune Epitope Database (IEDB; http://mhcbindingpredictions. immuneepitope.org/dataset.html; Peters B, Sidney J, Bourne P, Bui H H, Buus S, Doh G, Fleri W, Kronenberg M, Kubo R, Lund O, Nemazee D, Ponomarenko J V, Sathiamurthy M, S choenberger S, Stewart S, Surko P, Way S, Wilson S, Sette A. The immune epitope database and analysis resource: from vision to blueprint. PLoS Biol. 2005 March; 3(3):e91). The representations of the ligand-receptor interactions are then converted into a format (similar to the format in Example 3—FIG. 4(c)) for training a SVM.

Using the above converted representations, a SVM was trained for each HLA class I molecule with the SVMLight software (Joachims T, Making large-scale SVM learning practical. Advances in kernel methods—support vector learning, Schölkopf B, Burges C, Smola A (eds.), MIT-Press, 1999). The third-degree polynomial kernel function was used to encode descriptors (for example, representations of the peptide contact residues at the peptide interaction site of a protein as shown in FIG. 4(a)) derived from the rotamer library. The binding scores used for SVM training were set as 0 and 1 for non-binders (i.e. non-binding peptides) and binders (i.e. binding peptides) respectively.

Binding of peptides to molecules A*0101, A*0201 (see Examples 1 and 2), A*0202, A*0203, A*0301, A*1101, A*2301, A*2601 and B*2705 (see Example 3) were predicted using individual SVMs (one SVM for each molecule) trained according to the embodiments of the present invention. The results of the predictions using the embodiments of the present invention are shown in Table 2. As shown in Table 2, the results show that the predictive power of method 108 is comparable, if not better than those of existing algorithms. In fact, with higher quality 3-D structures, the predictive power of method 108 may be further improved.

TABLE 2

| | | Data size | | |
|---|---|---|---|---|
| | | Training | | Accuracy |
| Alleles | Template type | set | Test set | (%) |
| A*0101 | Theoretical model | 925 | 233 | 92.67 |
| A*0201 | X-ray crystal | 2471 | 618 | 88.51 |
| | (PDB ID 1OGA, 1.40 Å res.) | | | |
| A*0202 | Theoretical model | 1157 | 290 | 86.55 |
| A*0203 | Theoretical model | 1154 | 289 | 81.60 |
| A*0301 | Theoretical model | 1675 | 419 | 85.92 |
| A*1101 | Theoretical model | 1588 | 397 | 94.27 |
| A*2301 | Theoretical model | 83 | 21 | 76.19 |
| A*2601 | Theoretical model | 128 | 32 | 93.33 |
| B*2705 | X-ray crystal | 775 | 194 | 94.33 |
| | (PDB ID 2A83, 1.40 Å res.) | | | |

In summary, the embodiments of the present invention serve to evaluate potential binding of peptide-like ligands (ligands) to peptide-like receptors (receptors) by using predictive models trained using non-linear statistical techniques (such as probability density function, multiple regression system, ANN, HMM, SVM, matrices, among others), 3-D structural data of ligand-receptor complexes, and known or estimated ligand-receptor binding affinities.

The advantages of the embodiments of the present invention are as follows. These advantages allow the embodiments of the present invention to achieve more accurate results (as validated using data on peptide binding to major histocompatibility complex molecules (MHC)).

### Use of an Expansive Rotamer Library

Unlike existing techniques, the embodiments of the present invention utilize a rotamer library comprising not only a base ligand-receptor interaction of known or estimated affinity but also ligand-receptor interactions derived from this base ligand-receptor interaction. In this way, the rotamer library may comprise all possible ligand-receptor interactions for the receptor of interest.

By utilizing such an expansive rotamer library, the predictive model can be trained with a larger amount of data and thus will be more accurate in evaluating potential ligand-receptor interactions. Furthermore, the use of such a rotamer library can reduce the computational time required for predicting the ligand-receptor interactions.

### Use of a Predictive Model Trained Using Non-Linear Statistical Means

In the embodiments of the present invention, a non-linear statistical predictive model is built and applied for evaluating potential ligand-receptor interactions. This involves several stages:
a) representing known or estimated (training) receptor-ligand interactions in a format useful for training the predictive model;
b) training the predictive model;
c) representing an unknown (test) ligand-receptor interaction in the same format as in (a); and
d) predicting the binding affinity of the unknown ligand-receptor interaction.

In the embodiments of the present invention, the predictive model is trained using derived input data (or representations) characterizing instances of ligand-receptor interactions with known 3D structures or with theoretical models. In other words, the embodiments of the present invention facilitate the use of machine-learning on 3-D structures or theoretical models for prediction of binding activities between ligands and receptors. Furthermore, the predictive model is trained using non-linear statistical means such as probabilistic function, ANN, HMM, SVM, multiple regression or Bayesian network.

As new experimental data becomes available, the predictive model can be re-trained with this new data to improve its accuracy. This achieves cyclical refinement of the embodiments of the present invention and hence, provides a way to constantly improve the accuracy of these embodiments.

Training of Predictive Model Using Representations Based on Contact Elements Derived from 3-D Structures

In the embodiments of the present invention, representations of the ligand-receptor interactions (formed in step 104) for each single data training point combine both experimental and structural information. Furthermore, these representations are not derived from the ligand, receptor or ligand-receptor primary sequences. Rather, they are based on the actual ligand-receptor contact elements derived from 3-D structures (which may be experimentally solved 3-D protein structures or theoretical models such as those derived from homology modeling, molecular docking and/or protein threading techniques). In other words, the reciprocal relationship between a ligand and a receptor is characterized in terms of parameters which relate to the ligand-receptor interaction derived from 3-D biomolecular structures and the predictive model predicts binding affinity and biological activity on the basis of this reciprocal relationship.

The above is advantageous as it is usually the characteristics of the interaction or binding event of the actual contact elements which are important rather than the sequence of the ligand alone or in combination with the sequence of the entire receptor binding site. Thus, by using the actual contact elements derived from 3-D structures to train the predictive model, the behavior of multiple related ligands towards a single receptor, or a single ligand towards multiple related receptors, may be assessed more accurately.

### Single Representation

In the embodiments of the present invention, each ligand-receptor interaction is represented by a single representation. In one example, this is formed by combining representations of different characteristics of the interaction (for example, receptor contact elements and ligand contact elements).

Using only a single representation allows the embodiments of the present invention to be less computationally intensive.

### Multiple Applications

The embodiments of the present invention are applicable in the fields of computational biology, computational chemistry, protein engineering, vaccine discovery and drug discovery. They concern the identification and prediction of ligand-receptor activities which may in turn be used to identify biologically active compounds and ligands to families of related receptors.

The embodiments of the present invention can be used for predicting ligand-receptor interaction patterns or binding activities. For example, they allow high accuracy predictions of ligand binding to receptor molecules when no experimental data for such binding is available.

The embodiments of the present invention can also be used to identify and predict unknown ligand or receptor activity, using information derived from the three-dimensional structure or model of a ligand, receptor or ligand-receptor complex with known binding affinity. For example, the embodiments can be used to screen a binding candidate to a particular receptor for which no experimental data or three-dimensional structure is available. This screening may be improved by inclusion of new experimental data to refine the predictive model. Furthermore, the embodiments of the present invention can be used to predict the activity of molecules for which no experimental data is available. This prediction may also be improved by inclusion of new experimental data to refine the predictive model.

The embodiments of the present invention also enable large-scale, high-throughput screening of receptor-binding ligands and have the ability to be adapted or generalized for the prediction of receptor-ligand interactions for various receptor families. The embodiments of the present invention can also be generalized for the prediction of all types of ligand-receptor interactions for various receptor families including, but not limited to, MHC molecules, T cell receptors, immunoglobulins, ion channel blockers and protein cleavage. Furthermore, the embodiments of the present invention are generally applicable to data sets based on any type of ligand-receptor interaction.

The following are some example applications of the embodiments of the present invention:
1. Identifying novel ligand-receptor interactions
2. Identifying unknown binding counterparts of a receptor or ligand
3. Identifying unknown and secondary therapeutic targets of drugs, drug leads, drug candidates, natural products, etc
4. Identifying novel receptor or ligand molecules with similar functional sites as the source or target molecules
5. Predicting side effects and toxicities related to drugs (drug safety evaluation)
6. Predicting targets of drug ADME (Absorption, Distribution, Metabolism and Excretion), in other words, pharmacokinetics.

### REFERENCES

1. Altuvia Y, Schueler O, Margalit H. Ranking potential binding peptides to MHC molecules by a computational threading approach. J Mol Biol 1995; 249:244-250.
2. Bino J, Sali A. Comparative protein structure modeling by iterative alignment, model building and model assessment. Nucleic Acids Res 2003; 31:3982-3992
3. Bordner A J, Abagyan R. Ab initio prediction of peptide-MHC binding geometry for diverse class I MHC allotypes. Proteins 2006; 63:512-26.
4. Doytchinova I A, Flower D R. Toward the quantitative prediction of T-cell epitopes: coMFA and coMSIA studies of peptides with affinity for the class I MHC molecule HLA-A*0201. J Med Chem 2001; 44:3572-3581.
5. Joachims T, Making large-scale SVM learning practical. Advances in kernel methods—support vector learning, Schölkopf B, Burges C, Smola A (eds.), MIT-Press, 1999
6. Nielsen M, Lundegaard C, Worning P, et al. Reliable prediction of T-cell epitopes using neural networks with novel sequence representations. Protein Sci 2003; 12:1007-1017.
7. Mamitsuka H. Predicting peptides that bind to MHC molecules using supervised learning of hidden Markov models. Proteins 1989; 33:460-474.
8. Stewart-Jones G B, McMichael A J, Bell J I, et al. A structural basis for immunodominant human T cell receptor recognition. Nat Immunol 2003; 4:657-663
9. Michielin O, Luescher I, Karplus M. Modeling of the TCR-MHC-peptide complex. J Mol Biol 2000; 300:1205-1235.
10. Peters B, Sidney J, Bourne P, Bui H H, Buus S, Doh G, Fleri W, Kronenberg M, Kubo R, Lund O, Nemazee D, Ponomarenko J V, Sathiamurthy M, S choenberger S, Stewart S, Surko P, Way S, Wilson S, Sette A. The immune epitope database and analysis resource: from vision to blueprint. PLoS Biol. 2005 March; 3(3):e91.
11. Falk K, Rotzschke O, Stevanovic S, Jung G, Rammensee H G. Allele-specific motifs revealed by sequencing of self-peptides eluted from MHC molecules. Nature 1991; 351:290-296.
12. Ruckert C, Fiorillo M T, Loll B, Moretti R, Biesiadka J, Saenger W, Ziegler A, Sorrentino R, Uchanska-Ziegler B. Conformational dimorphism of self-peptides and molecular mimicry in a disease-associated HLA-B27 subtype. J Biol Chem 2006; 281:2306-2316
13. Schafer J R, Jesdale B M, George JA, et al. Prediction of well-conserved HIV-1 ligands using a matrix-based algorithm, EpiMatrix. Vaccine 1998; 16:1880-1884.
14. Segal M R, Cummings M P, Hubbard A E. Relating amino acid sequence to phenotype: analysis of peptide-binding data. Biometrics 2001; 57:632-642.
15. Tong J C, Tan T W, Ranganathan S. Methods and protocols for prediction of immunogenic epitopes. Brief. Bioinform. 2007; 8:96-108.
16. Zhao Y, Pinilla C, Valmori D, et al. Application of support vector machines for T-cell epitopes prediction. Bioinformatics 2003; 19:1978-1984.

1. A computer-implemented method for generating a predictive model for predicting ligand affinity with a receptor, the method comprising the steps of:
(i) using at least one source ligand which is known to interact with the receptor, to generate a plurality of additional ligands;
(ii) generating a database describing, for each of the plurality of additional ligands, a known or estimated affinity of the corresponding ligand with the receptor;
(iii) training a predictive model using the database.

2. A method for predicting the interaction between at least one specified ligand and a receptor comprising presenting the specified ligand to a predictive model generated for the receptor by a method according to claim 1.

3. A method according to claim 1, wherein the plurality of additional ligands are generated by:
identifying at least one base ligand-receptor interaction between the at least one source ligand and the receptor; and
modifying a portion of the corresponding source ligand selected according to the base ligand-receptor interaction, to produce at least one modified ligand.

4. A method according to claim 3, wherein the selected portion of the source ligand is known to bind with the receptor.

5. A method according to claim 3, wherein the selected portion of the source ligand comprises side chain coordinates of an amino acid residue of the source ligand wherein the side chain coordinates are known to bind with the receptor.

6. A method according to claim 5, wherein the sub-step of modifying a portion of the source ligand further comprises the sub-step of replacing the side chain coordinates of the amino acid residue of the source ligand with the side chain coordinates of a different amino acid residue.

7. A method according to claim 1, wherein the database comprises a plurality of ligand-receptor interactions and each ligand-receptor interaction in the database is defined by ligand contact elements and receptor contact elements of the ligand-receptor interaction.

8. A method according to claim 7, wherein the contact elements of the at least one source ligand are derived from a 3-D structure of a source-ligand-receptor complex including the source ligand and the receptor.

9. A method according to claim 8, wherein the 3-D structure of the source-ligand-receptor complex is a computational model or a theoretical model derived using one or more of homology modelling, molecular docking and protein threading.

10. A method according to claim 7, wherein the predictive model is trained according to the following sub-steps:
forming a representation for each ligand-receptor interaction in the database, the representation describing the characteristics of the ligand-receptor interaction; and
training the predictive model using the representations of the ligand-receptor interactions in the database.

11. A method according to claim 10, wherein the sub-step of forming a representation for each ligand-receptor interaction in the database further comprises the sub-steps of:
constructing a representation for each characteristic of the ligand-receptor interaction; and
combining the representations for the characteristics of the ligand-receptor interaction to form the representation for the ligand-receptor interaction.

12. A method according to claim 10, wherein the characteristics of the ligand-receptor interaction comprise one or more of the following: ligand contact elements of the interaction, receptor contact elements of the interaction, chemical bonds involved in the interaction and a strength of the interaction.

13. A method according to claim 12, wherein the representation for each ligand-receptor interaction is in the form LIS:TP-RIS-BA wherein LIS represents the ligand contact elements of the interaction, TP represents the chemical bonds involved in the interaction, RIS represents the receptor contact elements of the interaction and BA represents the strength of the interaction.

14. A method according to claim 12, wherein the ligand contact elements and the receptor contact elements exclude conserved residues.

15. A method according to claim 10, further comprising the sub-step of converting the representation for each ligand-receptor interaction to a format suitable for use with the predictive model prior to training the predictive model.

16. A method according to claim 1, wherein the affinity of the at least one source ligand and the receptor is estimated using knowledge of biological activity resulting from interaction between the at least one source ligand and the receptor.

17. A method according to claim 2 wherein the step of predicting the level of interaction between the at least one specified ligand and the receptor comprises the sub-steps of:
forming a representation for the potential interaction between the at least one specified ligand and the receptor, the representation for the potential interaction being in a same format as the representation of each ligand-receptor interaction in the database; and
presenting the representation for the potential interaction to the predictive model.

18. A method according to claim 17, further comprising a sub-step of converting the representation for the potential interaction between the specified ligand and the receptor to a format suitable for use with the trained predictive model prior to presenting the representation to the trained predictive model.

19. A method according to claim 1, wherein the predictive model is a SVM model.

20. A computer system having a processor and a data storage device storing software operative by the software to cause the processor to generate a predictive model for predicting ligand affinity with a receptor, by
(i) using at least one source ligand which is known to interact with the receptor, to generate a plurality of additional ligands;
(ii) generating a database describing, for each of the plurality of additional ligands, a known or estimated affinity of the corresponding ligand with the receptor; and
(iii) training a predictive model using the database.

21. A tangible data storage device, readable by a computer and containing instructions operable by a processor of a computer system to cause the processor to generate a predictive model for predicting ligand affinity with a receptor, by
(i) using at least one source ligand which is known to interact with the receptor, to generate a plurality of additional ligands;
(ii) generating a database describing, for each of the plurality of additional ligands, a known or estimated affinity of the corresponding ligand with the receptor; and
(iii) training a predictive model using the database.
